(19) United States
(12) Patent Application Publication
(10) Pub. No.: US 2025/0210917 A1
(43) Pub. Date: Jun. 26, 2025

(54) ELECTRICAL CONNECTOR

(71) Applicant: BELLWETHER ELECTRONIC CORP., Taoyuan City (TW)

(72) Inventor: Shih-Yang Hong, Taoyuan City (TW)

(21) Appl. No.: 18/927,347

(22) Filed: Oct. 25, 2024

Related U.S. Application Data
(60) Provisional application No. 63/612,396, filed on Dec. 20, 2023.

(51) Int. Cl. H01R 13/6471; H01R 12/72; H01R 13/405; H01R 13/516

(52) U.S. Cl. CPC H01R 13/6471; H01R 13/405; H01R 13/516; H01R 12/721

(57) ABSTRACT

An electrical connector includes an insulating housing, a terminal holder, two terminal groups, and a ground bar. The insulating housing has a slot. The terminal holder is disposed in the insulating housing. The two terminal groups are disposed in the insulating housing. The two terminal groups are arranged oppositely and fixed on the terminal holder, and each of the two terminal groups includes signal terminals and ground terminals that are arranged along a first direction. The ground bar is disposed on the terminal holder and electrically connected to the plurality of ground terminals, and the ground bar is configured to be parallel with the first direction. The ground bar includes a plurality of extension portions connected to a first long side of the ground bar. Each of the extension portions is directly connected to a plurality of ground wires of a plurality of cables.

### CROSS-REFERENCE TO RELATED PATENT APPLICATION

This application claims the benefit of priority to the U.S. Provisional Patent Application Ser. No. 63/612,396, filed on Dec. 20, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electrical connector, and more particularly to a PCI-E interface connector.

### BACKGROUND OF THE DISCLOSURE

Existing electrical connectors in compliance with the peripheral component interconnect express (PCI-E) standard use internal conductive terminals thereof to connect cables for high-speed transmission. For example, multiple ground terminals inside an electrical connector are each connected to a corresponding ground wire in the cables, and must be simultaneously connected to a common ground component to reduce interference between signals and ensure signal integrity. Due to the large number and small size of the ground terminals, the manufacturing process of the existing structural design is complicated and the manufacturing cost is high.

Therefore, how to overcome the above-mentioned defects through improvements in structural design has become one of the important issues to be addressed in this industry.

### SUMMARY OF THE DISCLOSURE

In response to the above-referenced technical inadequacies, the present disclosure provides an electrical connector in compliance with the peripheral component interconnect express (PCI-E) standard.

In order to solve the above-mentioned problems, one of the technical aspects adopted by the present disclosure is to provide an electrical connector. The electrical connector includes an insulating housing, a terminal holder, two terminal groups, and a ground bar. The insulating housing has a slot. The terminal holder is disposed in the insulating housing. The two terminal groups are disposed in the insulating housing. The two terminal groups are arranged oppositely and fixed on the terminal holder, and each of the two terminal groups includes a plurality of signal terminals and a plurality of ground terminals that are arranged along a first direction. The ground bar is disposed on the terminal holder and electrically connected to the plurality of ground terminals, and the ground bar is configured to be parallel with the first direction. The ground bar includes a plurality of extension portions connected to a first long side of the ground bar. Each of the extension portions is directly connected to a plurality of ground wires of a plurality of cables.

Therefore, in the electrical connector provided by the present disclosure, by the structural design of the ground bar and the extension portions of the ground bar, the ground bar is electrically connected to a plurality of terminals, and the ground wires of the cables do not need to be individually aligned with and connected to corresponding ground terminals. The ground wires of the cables only need to be connected to the extension portions to achieve the grounding effect.

These and other aspects of the present disclosure will become apparent from the following description of the embodiment taken in conconnecting portion with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an electrical connector according to a first embodiment of the present disclosure;

FIG. 2 is a schematic partially exploded view of the electrical connector according to the first embodiment of the present disclosure;

FIG. 3 is another schematic partially exploded view of the electrical connector according to the first embodiment of the present disclosure;

FIG. 4 is a schematic view of a ground bar of the electrical connector according to the first embodiment of the present disclosure;

FIG. 5 is a schematic view of ground terminals of the electrical connector according to the first embodiment of the present disclosure;

FIG. 6 is a schematic view of signal terminals, the ground terminals, and the ground bar of the electrical connector according to the first embodiment of the present disclosure;

FIG. 7 is a schematic view of the signal terminals, the ground terminals, and the ground bars being connected to cables of the electrical connector according to the first embodiment of the present disclosure; and

FIG. 8 is a schematic view of the signal terminals, the ground terminals, and the ground bars being connected to the cables of the electrical connector according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

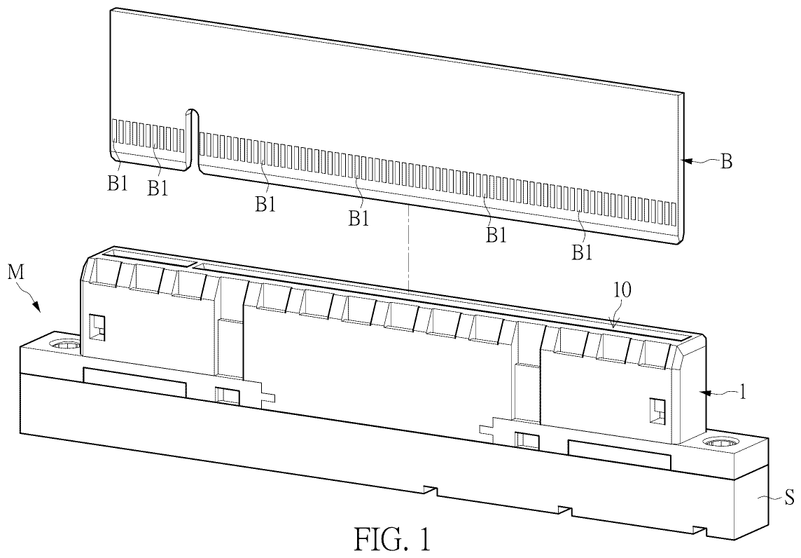

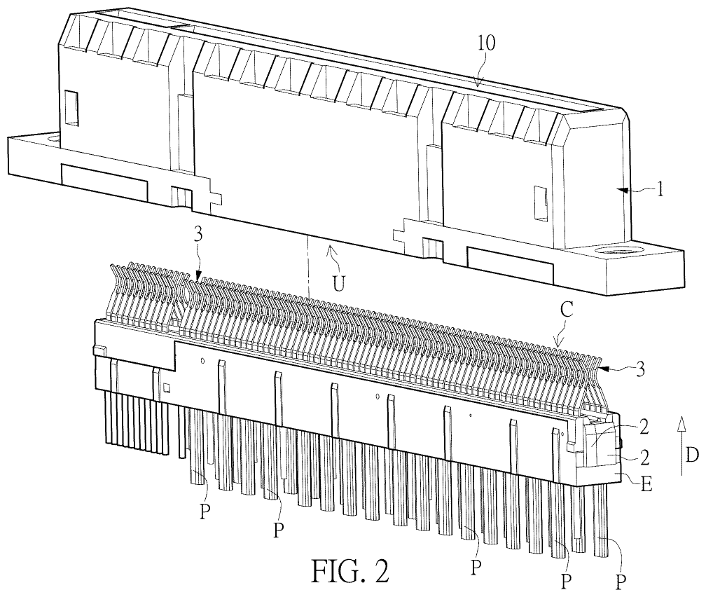

Referring to FIG. 1 to FIG. 3, a first embodiment of the present disclosure provides an electrical connector M in compliance with the peripheral component interconnect express (PCI-E) standard, and the electrical connector M includes an insulating housing 1, a terminal holder 2, two terminal groups 3, and a ground bar 4. One side of the insulating housing 1 has at least one slot 10 for an electronic card B to be inserted therein. Another side of the insulating housing 1 may include a cover S. The terminal holder 2 and the two terminal groups 3 are disposed in the insulating housing 1, and the ground bar 4 is disposed on the terminal holder 2. In the present disclosure, the terminal holder 2 is a package made of a plastic material by injection molding.

For example, a quantity of the ground bar 4 is two, and the two ground bars 4 are disposed on the terminal holder 2. The terminal holder 2 can be a single structure or two independent structures that can be combined with each other. The two terminal groups 3 are arranged oppositely and are respectively fixed on the two independent structures of the terminal holder 2. Each of the two terminal groups 3 includes a plurality of terminals arranged along a first direction D1, such that the plurality of terminals of the two terminal groups 3 are arranged in two opposite rows to form an insertion port C. The two terminal groups 3 can be inserted into the insulating housing 1 from an opening U located on the another side of the insulating housing 1, such that the insertion port C is connected to the slot 10. Therefore, when the electronic card B is inserted into the slot 10, the electronic card B is also inserted into the insertion port C so as to be electrically connected to the two terminal groups 3. In addition, the electrical connector M of the present disclosure is connected to a plurality of cables P. The cables P may be, for example, twin cables that include two signal wires and two ground wires. The cables P are electrically connected to the plurality of terminals of the two terminal groups 3. In addition, the electrical connector M may further include a fixing mechanism E for fixing the cables P and the terminal holder 2.

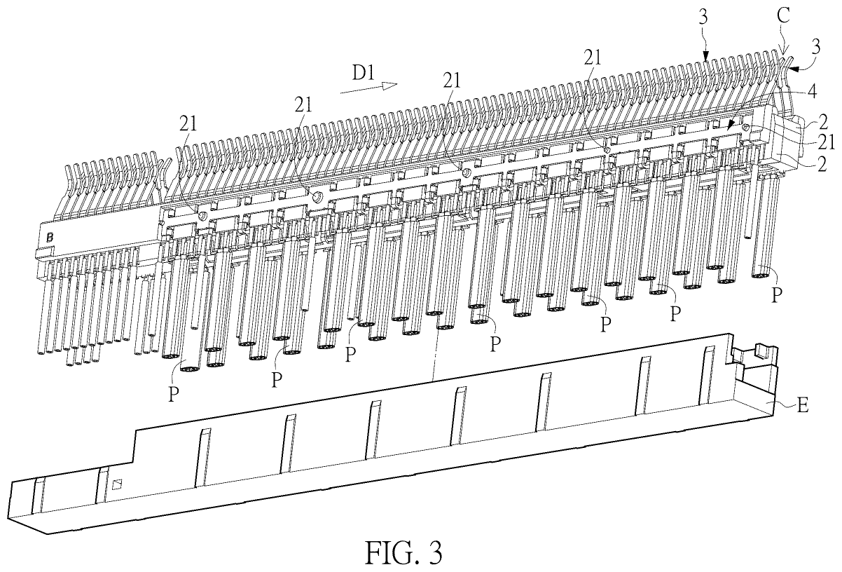

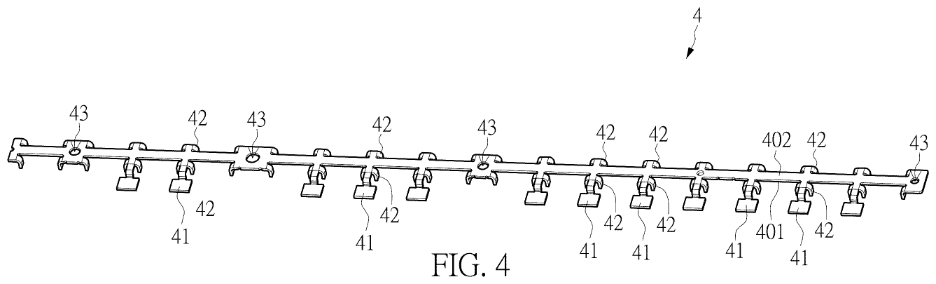

Referring to FIG. 3 and FIG. 4, the ground bar 4 includes a long body, and a first long side 401 and a second long side 402 of the long body are opposite to each other. The ground bar 4 includes a plurality of extension portions 41 that are electrically connected to the first long side 401 and are disposed in a plurality of grooves of the terminal holder 2. The ground bar 4 further includes a plurality of connecting portions 42 connected to the first long side 401 and/or the second long side 402. The plurality of extension portions 41 can be connected to the plurality of connecting portions 42 arranged on the first long side 401. In addition, the terminal holder 2 includes a plurality of positioning posts 21, and the ground bar 4 includes a plurality of positioning holes 43. The terminal holder 2 fixes a position of the ground bar 4 by the plurality of positioning posts 21 respectively inserted in the plurality of positioning holes 43.

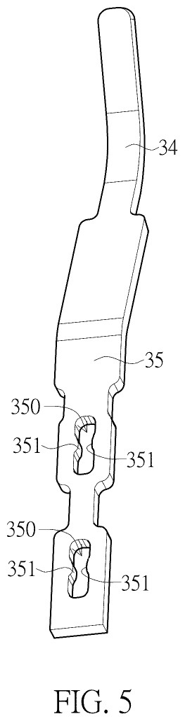

Referring to FIG. 3 and FIG. 5, each of the terminals at least includes a contact portion 34 and a body portion 35. The contact portion 34 is connected to one end of the body portion 35. The plurality of contact portions 34 in the two terminal groups 3 are arranged oppositely to form the insertion port C. The body portion 35 has at least one connecting hole 350, and an inner wall of each of the connecting holes 350 has a plurality of symmetrically arranged protrusions 351.

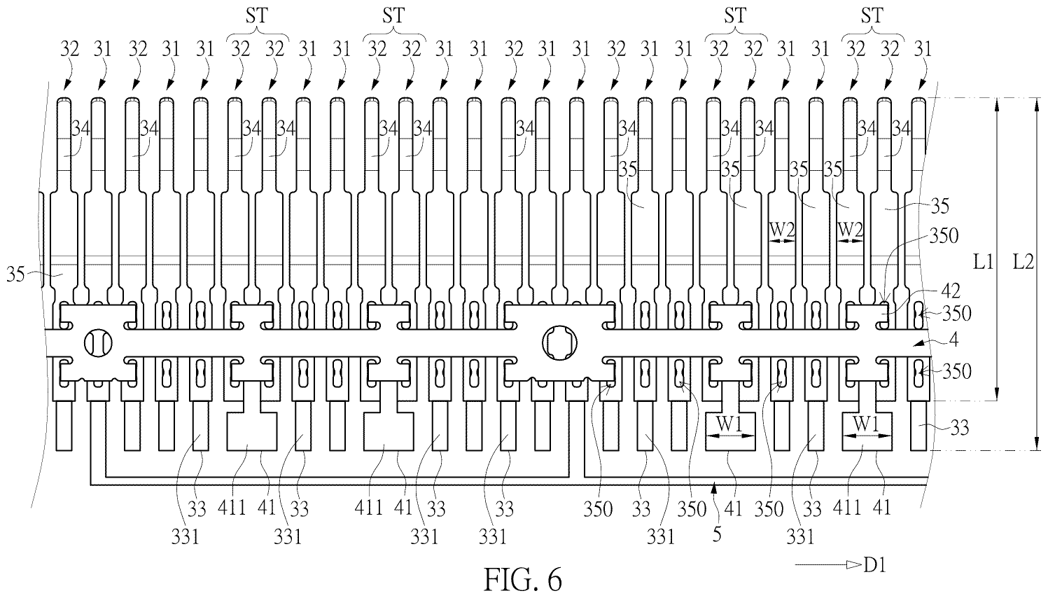

Referring to FIG. 4 to FIG. 6, for convenience of illustration, FIG. 6 only shows the ground bar 4 and a plurality of terminals, and other components are omitted. In the present disclosure, certain terminals of each of the two terminal groups 3 further includes leg portions 33, and the leg portions 33 are connected to another end of the body portion 35, that is, the body portion 35 is connected between the leg portion 33 and the contact portion 34. The terminals of each of the two terminal groups 3 include a plurality of signal terminals 31 and a plurality of ground terminals 32. As shown in FIG. 6, parts of the ground terminals 32 of the plurality of ground terminals 32 are arranged adjacently in pairs to form a plurality of ground terminal pairs ST. The plurality of extension portions 41 respectively correspond to the plurality of ground terminal pairs ST. The plurality of connecting holes 350 respectively correspond to the plurality of connecting portions 42. Two sides of each of the connecting portions 42 are bent and inserted into the connecting holes 350 of the corresponding ground terminals 32, so as to be in contact with the protrusions 351 in the connecting hole 350.

As shown in FIG. 6, specifically, the ground terminals 32 in the plurality of ground terminal pairs ST do not have the leg portions 33, thus have shorter length. Therefore, a length L1 of the ground terminals 32 of the ground terminal pair ST is shorter than a length L2 of the signal terminals 31 and also shorter than the length of other ground terminals 32 that are not in pairs. In other words, only the plurality of signal terminals 31 and the ground terminals 32 of the plurality of ground terminals 32 that are not arranged adjacently in pairs have the leg portions 33. Each of the extension portions 41 has a first contact surface 411, each of the leg portions 33 has a second contact surface 331, and the first contact surface 411 is flush with the second contact surface 331. A width W1 of the first contact surface 411 in the first direction D1 is greater than a width W2 of any section on any terminal in the first direction D1.

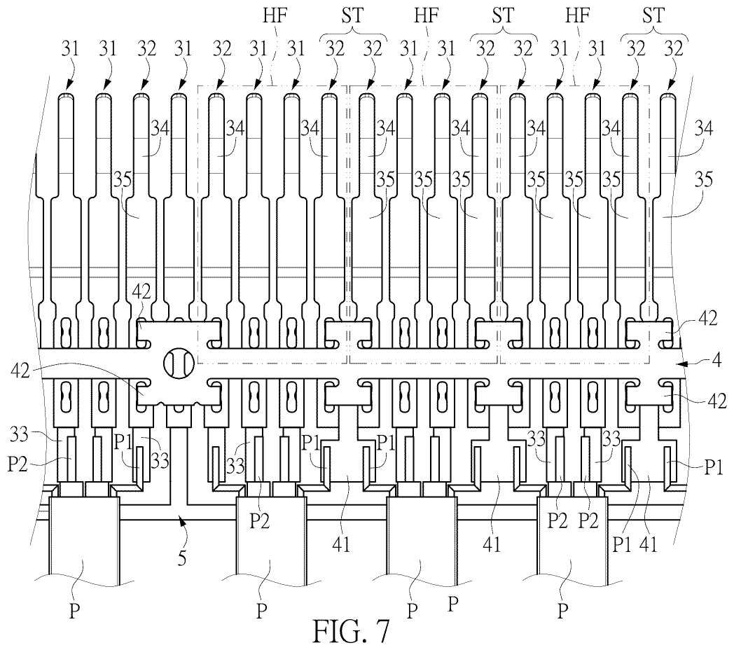

Referring to FIG. 6 and FIG. 7, multiple terminals of each of the two terminal groups 3 can form a plurality of high-frequency groups HF (i.e., the terminals enclosed by dotted lines in FIG. 7). Each of the high-frequency groups HF includes two signal terminals 31 and two ground terminals 32. The two signal terminals 31 are located between the two ground terminals 32, and at least two of the plurality of signal terminals 31 are not arranged in any of the high-frequency groups HF. The signal terminals 31 of two of the high-frequency groups HF are used to transmit high-frequency signals, and the signal terminals 31 that do not belong to the high-frequency groups HF are used to transmit low-frequency signals. The electrical connector M further includes a common rod 5 connected to at least part of the signal terminals 31 that transmit low-frequency signals (that is, the signal terminals 31 that do not belong to any of the high-frequency groups HF). At least two signal terminals 31 among the plurality of signal terminals 31 perform signal transmission through the common rod 5. The plurality of ground wires P1 in the plurality of cables P (e.g., one ground wire of each of two adjacent twin-axial cables) are in contact with the first contact surface 411 by welding or other fixed connection manners to be electrically connected to the plurality of extension portions 41. The plurality of signal wires P2 are in contact with the second contact surface 331 to be electrically connected to the plurality of leg portions 33. More specifically, the first contact surface 411 of each of the extension portions 41 can accommodate two ground wires P1 (since the width W1 of the first contact surface 411 is greater), and the second contact surface 331 of each of the leg portions 33 is only capable of accommodating one of the signal wires P2.

Comparing to existing electrical connectors, in which each of the ground terminals is connected to a corresponding ground wire, the electrical connector M provided by the present disclosure has multiple extension portions 41 provided on one side of the ground bar 4, and the width of the contact surface of each of the extension portions 41 is increased, such that the contact surface can be electrically connected to multiple ground wires P1 (e.g., one extension portion 41 is connected to two ground wires P1). In other words, the ground wires P1 are in direct contact with the extension portions 41 without being required to be aligned and connected to the corresponding ground terminals. Therefore, the entire manufacturing process can be simplified and the manufacturing cost can be reduced. In short, through the structural design of the ground bar 4 and the extension portions, the electrical connector M provided by the present disclosure allows the ground bar 4 to be electrically connected to multiple terminals. The ground wires of the cables do not need to be individually aligned and connected to corresponding ground terminals, and only need to be connected to the extension portions to achieve the grounding effect.

### Second Embodiment

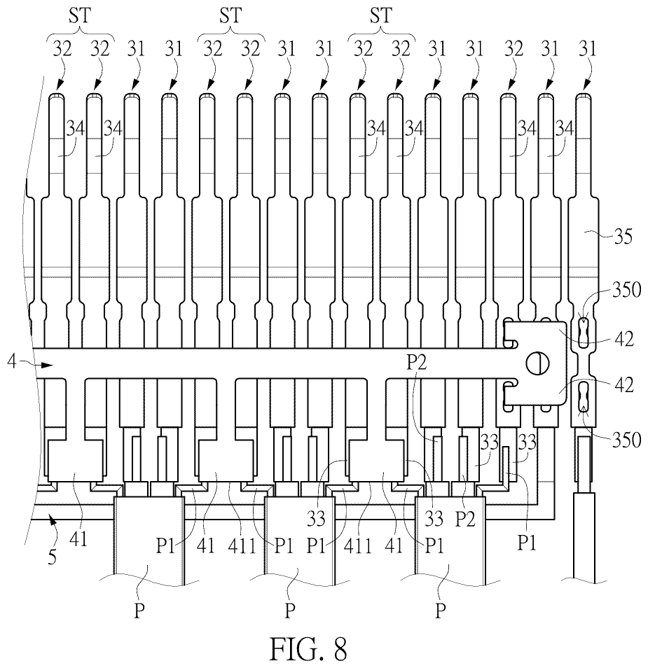

Referring to FIG. 8, a second embodiment of the present disclosure provides another electrical connector M. The electrical connector M of the second embodiment has a structure similar to that of the first embodiment, and the similarities will not be reiterated herein. One of the main differences is that, in the second embodiment, the lengths of all terminals are the same, that is, each of the ground terminals 32 in the plurality of ground terminal pairs ST also includes the leg portion 33.

Furthermore, in the second embodiment, the extension portions 41 in the ground bar 4 corresponding to each of the ground terminal pairs ST are directly stacked on the leg portions 33 of the ground terminals 32 of the ground terminal pairs ST and are in direct contact with the leg portions 33 for electrical connection, and the ground wires P1 of the cables P are directly connected to upper surfaces of the extension portions 41. Therefore, the first contact surfaces 411 of the extension portions 41 are located outside the second contact surfaces 331 of the leg portions 33 and are not flush with each other. In other words, compared with the first embodiment (as shown in FIG. 7), the ground bar 4 does not need to be connected to the ground terminals 32 of the ground terminal pairs ST through an additional connecting portion 42, but is in direct connection with the ground terminals 32 of the ground terminal pairs ST through the extension portions 41. That is to say, all terminals (including the signal terminals 31 and the ground terminals 32) can be the same, in which all terminals can include the leg portions 33 and the connecting holes 350, and the connecting portions 42 of the ground bar 4 are connected to the connecting holes 350 of the ground terminals 32; alternatively, as shown in FIG. 8, the extension portions 41 and the connecting portions 42 of the ground bar 4 are individually provided, such that the ground terminals 32 are electrically connected to the ground bar 4 through one of the extension portions 41 and the connecting portions 42 to have a common ground. That is, the extension portions 41 directly extend from one of the first long side 401 and the second long side 402 without being connected to that through the connecting portions 42. Compared with the first embodiment, the quantity of the connecting portions 42 can be reduced and the number of the connecting holes 350 of the ground terminals 32 corresponding to the reduced connecting portions 42 can also be reduced.

Furthermore, from a top view of FIG. 8, the extension portions 41 substantially overlap with the leg portions 33 of the ground terminals 32 in the ground terminal pairs ST. Preferably, a width of overlapping portions of projections of the extension portions 41 projected onto the ground terminal pairs ST in the first direction D1 is at least 50% of a width of the leg portions 33 of the ground terminals 32 in the ground terminal pairs ST in the first direction D1.

### Beneficial Effects of the Embodiments

In conclusion, the electrical connector M provided by the present disclosure is capable of electrically connecting multiple extension portions 41 by providing a plurality of extension portions 41 on one side of the ground bar 4 and increasing widths of the contact surfaces of the extension portions 41 such that the contact surface is able to be in electrical connection with multiple ground wires P1 (e.g., one extension portion 41 is connected to two ground wires P1). In other words, the ground wires P1 are directly in contact with the extension portions 41 without the need to be aligned and connected to the corresponding ground terminals. Therefore, the entire manufacturing process can be simplified and the manufacturing cost can be reduced. In short, through the structural design of the ground bar 4 and the extension portions, the electrical connector M provided by the present disclosure allows the ground bar to be electrically connected to multiple terminals, and the ground wires of the cables do not need to be individually aligned and connected to corresponding ground terminals, and only need to be connected to the extension portions to achieve the grounding effect.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electrical connector, comprising:
an insulating housing having a slot;
a terminal holder disposed in the insulating housing;
two terminal groups disposed in the insulating housing, wherein the two terminal groups are arranged oppositely and fixed on the terminal holder, and each of the two terminal groups includes a plurality of signal terminals and a plurality of ground terminals that are arranged along a first direction; and
a ground bar disposed on the terminal holder, wherein the ground bar is electrically connected to the plurality of ground terminals, and the ground bar is configured to be parallel with the first direction; wherein the ground bar includes a plurality of extension portions, the plurality of extension portions are connected to a first long side of the ground bar, and each of the extension portions is directly connected to a plurality of ground wires of a plurality of cables.

2. The electrical connector according to claim 1, wherein parts of the ground terminals of the plurality of ground terminals are arranged adjacently in pairs to form a plurality of ground terminal pairs, and a length of the ground terminal of each of the ground terminal pairs is smaller than a length of each of the signal terminals.

3. The electrical connector according to claim 2, wherein the plurality of extension portions respectively correspond to the plurality of ground terminal pairs, each of the plurality of extension portions has a first contact surface, and the plurality of ground wires of the plurality of cables are in contact with the first contact surface, wherein the plurality of signal terminals and another portion of the ground terminals that are not adjacently arranged in pairs among the plurality of ground terminals each have a leg portion.

4. The electrical connector according to claim 3, wherein each of the plurality of leg portions has a second contact surface, and the first contact surface is flush with the second contact surface.

5. The electrical connector according to claim 3, wherein a width of the first contact surface in the first direction is greater than a width of any section on any of the signal terminals and any section on any of the ground terminals in the first direction.

6. The electrical connector according to claim 1, wherein the plurality of extension portions are disposed in a plurality of grooves of the terminal holder.

7. The electrical connector according to claim 1, wherein a plurality of signal terminals and a plurality of ground terminals are used to form a plurality of high-frequency groups, and each of the high-frequency groups includes two of the signal terminals and two of the plurality of ground terminals, the two of the signal terminals are located between the two of the ground terminals, and at least two of the plurality of signal terminals do not belong to any of the high-frequency groups.

8. The electrical connector according to claim 7, further comprising a common rod connected to parts or all of at least two of the signal terminals that do not belong to any one of the high-frequency groups.

9. The electrical connector according to claim 1, wherein the ground bar further has a second long side, and the second long side is opposite to the first long side; wherein the ground bar further includes a plurality of connecting portions disposed on at least one of the first long side and the second long side, and each of the connecting portions is electrically connected to one of the plurality of ground terminals.

10. The electrical connector according to claim 9, wherein each of the extension portions is connected to one of the plurality of connecting portions arranged on the first long side.

11. The electrical connector according to claim 9, wherein each of the plurality of signal terminals and the plurality of ground terminals includes a contact portion and a body portion that are connected to each other, and the body portion has a plurality of connecting holes; wherein an inner wall of each of the connecting holes has a plurality of protrusions, and each of the connecting portions is bent and inserted into the corresponding connecting holes to be in contact with the plurality of protrusions.

12. The electrical connector according to claim 1, wherein the terminal holder includes a plurality of positioning posts, the ground bar includes a plurality of positioning holes, and the terminal holder fixes a position of the ground bar by the plurality of positioning posts respectively inserted in the plurality of positioning holes.

13. The electrical connector according to claim 1, wherein parts of the ground terminals of the plurality of ground terminals are arranged adjacently in pairs to form a plurality of ground terminal pairs, and the plurality of extension portions are directly stacked on leg portions of two of the ground terminal pairs of the plurality of ground terminal pairs and are electrically connected to the leg portions.

14. The electrical connector according to claim 13, wherein each of the extension portions has a first contact surface, each of the leg portions has a second contact surface, the first contact surface and the second contact surface are not flush with each other, and the plurality of ground wires of the plurality of cables are in contact with the first contact surface.
